(19) United States
(12) Patent Application Publication
(10) Pub. No.: US 2001/0043014 A1
(43) Pub. Date: Nov. 22, 2001

(54) Power distribution device comprising bars applied to a plate

(76) Inventors: Jean-Clair Pradier, Houilles (FR); Philippe Perez, Sevres (FR)

Correspondence Address: LARSON & TAYLOR, PLC, 1199 NORTH FAIRFAX STREET, SUITE 900, ALEXANDRIA, VA, 22314, US

(21) Appl. No.: 09/789,537

(22) Filed: Apr. 19, 2001

(30) Foreign Application Priority Data
Feb. 23, 2000 (FR) 00 02271

(51) Int. Cl. H02J 4/00

(52) U.S. Cl. 307/147

(57) ABSTRACT

The power distribution device comprises an insulating plate (12) and power conducting bars (14) carried by said plate (12). The device further comprises means for fixing the conducting bars (14) to a surface (18) of the plate (12). For at least some of the bars, the fixing means comprise a film of adhesive (20) interposed between the surface of the plate (12) and at least chosen zones on the surface of the bars (14) applied to the surface (18) of the plate (12).

The present invention relates to a power distribution device of the type comprising an insulating plate and power conducting bars carried by said plate, the device further comprising means for fixing the conducting bars to a surface of the plate.

In a power distribution network, especially installed in an aircraft, it is known to provide power distribution devices comprising a set of power contactors.

More precisely, in the case of an aeroplane, power distribution devices of this kind are installed in what is generally referred to as the electric core. The latter is supplied by a primary distribution network coming from generators which are integrated, for example, in the reactor of the aircraft.

The current produced by the generators is generally a three-phase current, so that, for each generator, three conductors corresponding to the three phases are routed to the power distribution box. A power contactor is provided in the distribution box for each power generator. This contactor ensures that each of the phases is connected simultaneously to a secondary power distribution network supplying the functional components of the aircraft. Each contactor is thus adapted to ensure the simultaneous disconnection of the three phases under the control of a command signal received at a suitable connector.

There are also contactors known as transfer contactors which enable secondary distribution networks to be supplied by a generator other than the one which is normally allocated to them, in the event of the latter breaking down.

The three conductors coming from each generator are connected to terminals placed at the ends of an insulating plate on which the power contactors are mounted. For each of the phases, the electric current is carried to the plate through metal bars applied to the surface of the plate. The conducting bars are arranged side by side, sufficiently far apart to ensure that they are electrically insulated. The power contacts are also mechanically attached to the plate.

In known devices, the conducting bars are applied to the upper surface of the plate and bolted thereto. For this purpose, coaxial bores through which the bolt shanks can pass are provided in the plate and in the conducting bars.

Because of the high power circulating in the conducting bars, they are of considerable cross section, of the order of 100 mm².

It will be appreciated that, owing to the large number of bars-passing over the upper surface of the plate, the space needed to install the connectors for the functional components, the presence of bolts securing each bar to the plate, and the terminals required to attach the supply cables, the plate is relatively large in size, thus increasing the bulk and weight of the power distribution device.

The aim of the invention is to propose a power distribution device of reduced size and mass.

To this end, the invention relates to a power distribution device of the type described above, characterised in that, for at least some of the bars, the fixing means comprise a film of adhesive interposed between the surface of the plate and at least chosen zones on the surface of the bars applied to the surface of the plate.

According to particular embodiments, the power distribution device has one or more of the following features:

it comprises functional components carried by said plate (12) and means for electrically connecting the functional components to said bars, and said electrical connecting means are adapted to ensure additional fixing of the conducting bars to said plate;

said means for fixing the conducting bars to the plate comprise only the film of adhesive and said means for electrically connecting the functional components to the bars;

said means for electrically connecting the functional components to the bars comprise at least one screw passing through a bore provided in a conducting bar, the or each screw simultaneously mechanically connecting the functional component to the plate and securing the bar to the surface of the plate;

the plate has clearances provided underneath said bars;

the conducting bars are metal bars having a cross section equal to at least 10 mm²; and

for each bar, the ratio of the width of the bar to its thickness is less than 10.

The invention will be better understood from the following description, provided solely by way of example and referring to the drawings, wherein:

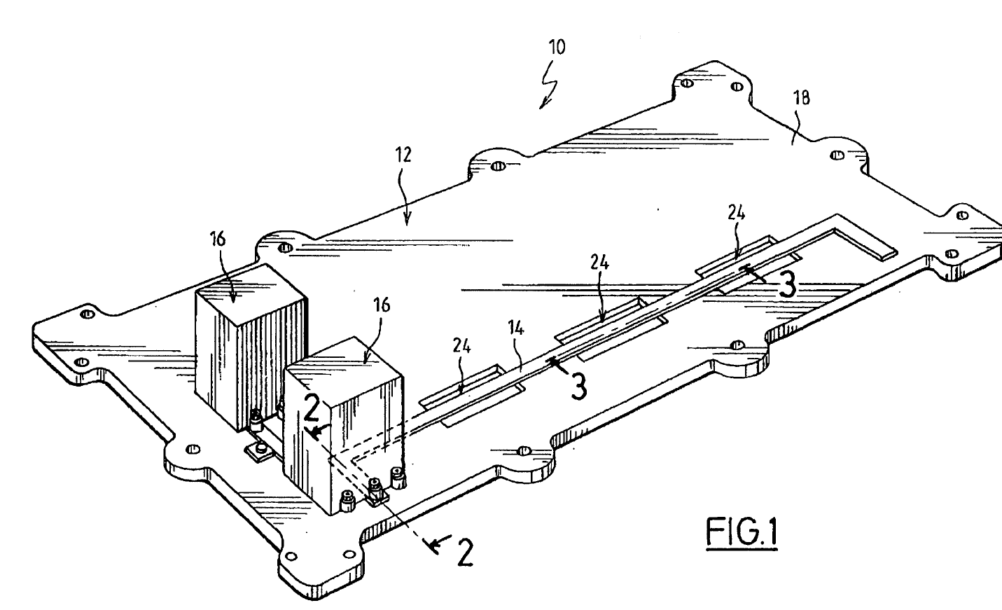

FIG. 1 is a partial perspective view of a power distribution device according to the invention;

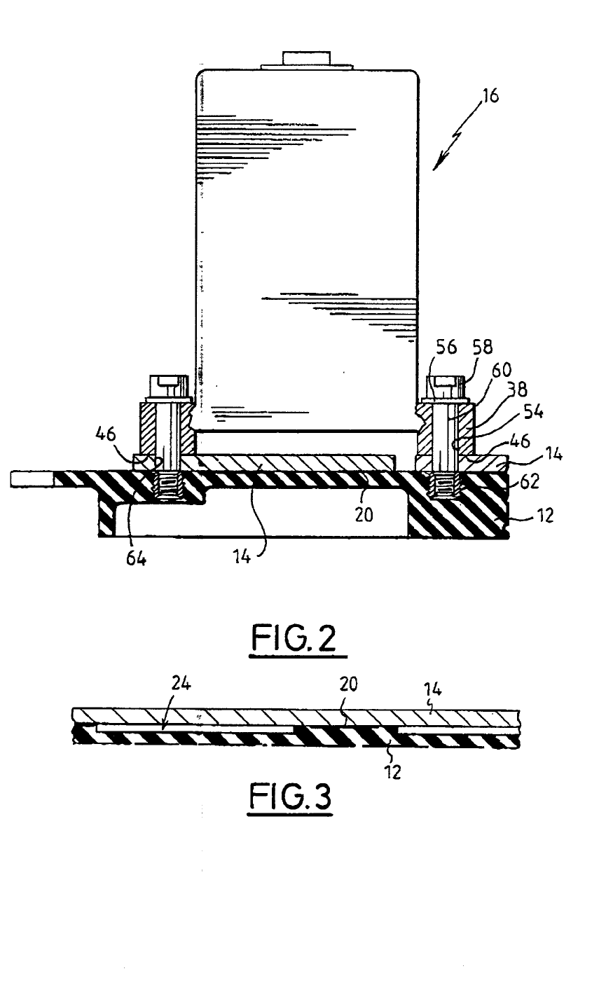

FIG. 2 is a partial sectional view of the power distribution device according to the invention, along the line 2-2; and

FIG. 3 is a sectional view of the power distribution device along the line 3-3 in FIG. 1.

FIG. 1 shows a power distribution device 10 with only some of its elements shown, in the interests of clarity.

The power distribution device essentially comprises an insulating plate 12, conducting bars 14 carried by an upper surface of the plate and functional components 16 electrically connected to the conducting bars 14, these functional components being power contactors, for example.

This power distribution device is intended to be installed in an aircraft.

The plate 12 is made from a composite insulating material. It consists, for example, of glass fibres embedded in an epoxy resin.

The plate 12 has a substantially flat upper surface defining a support surface for the conducting bars 14.

The conducting bars 14 are made of copper or aluminum, for example. They are formed by metallic elements machined from sheet metal of constant thickness, this thickness being 6 mm, for example.

The width of the bars measured along the surface 18 is 15 mm, for example.

Thus, the cross section of the bars 14 is equal to 90 mm², for example.

The ratio of the width of the bars to the thickness thereof is in practice less than 10.

For the type of application in question, the cross section of the bars 14 is typically greater than 10 mm².

To ensure that the bars 14 are mechanically secured to the upper surface 18 of the plate, and as shown in FIGS. 2 and 3, a film of adhesive 20 is interposed between the conducting bars 14 and the surface 18. This film of adhesive is provided in chosen areas along the length of each of the bars.

A suitable adhesive for fixing the conducting bars 14 to the plate if the bars are made of copper is an epoxy type resin, for example. An adhesive of this kind is the adhesive marketed by the company CIBA under the name “Araldite AV 119”.

The plate 12 comprises, along the length of the bars, successive clearances 24 extending underneath the bars. These clearances 24 are formed either by openings passing right through the thickness of the plate 18 or by cavities opening only on the upper surface of the plate.

The adhesive 20 is therefore applied only along separate successive sections of the length of the bars. The length of the glued sections makes up between 20 and 400 of the total length of the bars.

The power contactors 16 are electrically connected to the bars 14 and mechanically joined to the plate 12 by the same means. These latter are formed by connection terminals provided on the power contactors and screws passing through the connection terminals and bores provided in the bars 14, the threaded ends of the screws cooperating with screw-threaded inserts embedded in the plate.

More precisely, as shown in FIG. 2, the power contactors 16 comprise a substantially parallelepipedinal housing 34, from which six electrical connection terminals 38 for the power contactor emerge.

The connection terminals 38 are provided at one end of the housing, close to the lower surface.

The connection terminals 38 comprise conductive surfaces 46 bearing directly on conducting bars 14 carried on the surface of the plate 12. These bearing surfaces 46 are substantially coplanar.

Each connection terminal 38 has a hole 54 passing right through it, opening through the associated bearing surface 46. The hole 54 opens out at the other end of the connection terminals 38 through a surface 56. This surface 56 forms a bearing surface for a head 58 of a fixing screw 60. The threaded end of the screw is received in a screw-threaded insert 62 implanted in the insulating plate 12.

For attaching the power contactor to the plate and electrically connecting the contactor to the conducting bars, the conducting bars 14 have bores 64 to accommodate the screw shanks 60. The electrical connection between the power contactor and the conducting bars is provided at the interface formed by the bearing surfaces 46 applied to the upper surfaces of the conducting bars 14.

It will be appreciated that the screws 58 help to secure the conducting bars 14 to the plate 12 by the action of the screws 60 bearing on the bars 14 through the terminals 38.

According to the invention, the power distribution device has no other means of fixing the conducting bars 14 to the plate 12, the bars being held only by the films of adhesive 20 and the contactor connecting screws 60.

With a power distribution device as described here, the absence of bolts provided specifically for mechanically fixing the conducting bars 14 to the plate 12 reduces the total bulk of the plate, the space taken up by the bolts being wasted. Moreover, owing to the absence of bolts, there is no need to provide areas of increased width on the bars 14 to allow the drilling of bores to accommodate the bolts. Thus, there is a substantial reduction in the surface area needed for the mounting of the bars.

With a power distribution device as described here, the conducting bars 24 are secured both by the adhesive and by the means for electrically connecting the functional components 16 to the conducting bars. Thus, during operation, the functional components are secured by screwing into the plate through the bars 14, the bars 14 are firmly attached to the plate 12, thereby avoiding any risk of accidental shifting, even in the presence of powerful vibrational or thermal stresses within the aircraft.

Moreover, when the functional components are removed, e.g. for maintenance, the adhesive holding the bars 14 ensures that the bars remain in position even after the retaining screws for the functional components and bars have been removed.

The adhesive bonding thus provided between the bars and the plate is sufficient to hold the bars in place during any work on the plate.

Finally, it will be realised that the clearances 24 provided underneath the bars in the plate 18 allow satisfactory heat dissipation, avoiding excessive heating of the conducting bars, even when the conducting bars are applied and adhesively bonded to the upper surface of the plate along certain sections of their length.

Claims

1. Power distribution device of the type comprising an insulating plate (12) and power conducting bars (14) carried by said plate (12), the device further comprising means for fixing the conducting bars (14) to a surface (18) of the plate (12), characterised in that, for at least some of the bars, the fixing means comprise a film of adhesive (20) interposed between the surface of the plate (12) and at least chosen zones on the surface of the bars (14) applied to the surface (18) of the plate (12).

2. Device according to claim 1, characterised in that it comprises functional components carried by said plate (12) and means (60) for electrically connecting the functional components to said bars (14), and said electrical connecting means (60) are adapted to ensure additional fixing of the conducting bars (14) to said plate (12).

3. Device according to claim 2, characterised in that said means for fixing the conducting bars (14) to the plate (12) comprise only the film of adhesive (20) and said means (60) for electrically connecting the functional components to the bars.

4. Device according to claim 2 or 3, characterised in that said means for electrically connecting the functional components (16) to the bars (14) comprise at least one screw (60) passing through a bore (64) provided in a conducting bar, the or each screw (60) simultaneously mechanically connecting the functional component (16) to the plate (12) and securing the bar (14) to the surface of the plate (12).

5. Device according to any one of the preceding claims, characterised in that the plate (12) has clearances (24) provided underneath said bars (14).

6. Device according to any one of the preceding claims, characterised in that the conducting bars (14) are metal bars having a cross section equal to at least 10 mm².

7. Device according to any one of the preceding claims, characterised in that, for each bar, the ratio of the width of the bar to its thickness is less than 10.
